(19) United States
(12) Patent Application Publication
(10) Pub. No.: US 2007/0234929 A1
(43) Pub. Date: Oct. 11, 2007

(54) Method for Manufacturing a Composite Component and Metal-Ceramic Component

(76) Inventors: Bernd Reinsch, Ludwigsburg (DE); Iris Postler, Leonberg (DE); Klaus Czerwinski, Iggingen (DE); Matthias Leonhardt, Stuttgart (DE); Alwin Nagel, Esslingen (DE); Bernd Huchler, Buchs SG (CH); Dirk Staudenecker, Lorch (DE)

Correspondence Address: KENYON & KENYON LLP, ONE BROADWAY, NEW YORK, NY, 10004, US

(21) Appl. No.: 10/577,576

(22) PCT Filed: Oct. 4, 2004
(86) PCT No.: PCT/EP04/52416

§ 371 Date: Feb. 13, 2007

(30) Foreign Application Priority Data
Oct. 27, 2003 (DE) 103 50 035.9

(51) Int. Cl. C04B 41/51; C22C 1/10; F16D 65/12

(52) U.S. Cl. 106/1.18; 188/218 XL; 419/2

(57) ABSTRACT

A method for manufacturing a composite component, a brake disk in particular, and a metal-ceramic component are described. In the method, a porous ceramic blank is produced and infiltrated with a metal melt. An alloy of copper and at least one additional metal is used as the metal melt for infiltration, the additional metal being converted by at least one reactive component of the blank in such a way that a pore space of a ceramic phase is filled essentially with pure copper.

### FIELD OF THE INVENTION

The present invention is directed to a method for manufacturing a composite component and to a metal-ceramic component.

### BACKGROUND INFORMATION

Metal-ceramic components are known from practice and may be used in particular in tribological applications, such as brake disks. Such components are made of a ceramic-metal composite material and combine the property profiles of metallic and ceramic materials. They have great wear and corrosion resistance like ceramics, and are characterized by great damage tolerance and high thermal conductivity like metals. In addition, components made of ceramic-metal composite materials or metal-ceramic components have great mechanical stability, even at high temperatures.

Ceramic-metal composite materials may be formed as what is known as cast metal matrix composites (MMC_{cast}) in which up to 20% ceramic fibers or particles are added during the manufacture of a metal phase to be cast, or may also be formed as a preform-based metal matrix composite material (MMC_{pref}), which may have a ceramic content of possibly more than 60% and is more wear and corrosion resistant compared to cast metal matrix composites.

During the manufacture of a component made of a preform-based metal-matrix composite material, a porous ceramic blank is infiltrated or filled with a metal melt, with or without the use of outside pressure. The infiltration temperature must be selected as a function of the melting point of the metal phase to be infiltrated; in known preform-based metal-matrix composite materials, a desired low infiltration temperature results in a likewise low melting point of the metal phase in the finished component.

A method for manufacturing a metal-ceramic composite material is described in German Published Patent Application No. 197 06 925. In this method, the melting point of a metal phase is increased during the manufacturing process. This is achieved in that a mixture, in the form of a powder, of a ceramic and a low-melting eutectic metal alloy, which includes a metal which reacts with the ceramic, is heated under pressure, so that the reactive alloy component reacts with the ceramic phase, and the melting point of the residual metal phase increases during heating. This results in only the high-melting non-reactive metal component of the alloy remaining in the metal phase.

A method for manufacturing components made of a preform-based metal-matrix composite material is known from European Published Patent Application No. 0 859 410. In this method, a ceramic blank made of silicon carbide is infiltrated with copper or a copper alloy using a gas pressure infiltration method. During infiltration of the copper alloy, the melting point of the metal phase of the composite component is lower than during infiltration of pure copper, whose melting point is at 1,083° C. A composite material infiltrated with pure copper is therefore characterized by high maximum service temperatures which are correlated with the melting point of the metal phase of the composite material. However, the manufacture of such a composite component is also associated with high process temperatures.

High process temperatures result in an increased gas dissolution in the metal melt. This, as well as high thermal stresses of a casting tool used for the infiltration and of the blank must be avoided.

### SUMMARY OF THE INVENTION

The method according to the present invention for manufacturing a composite component, in particular a brake disk in which an alloy, made up of copper and at least one additional metal, is used as the metal melt, the additional metal, having at least one reactive component of the blank, is converted in such a way that a pore space of a ceramic phase is filled with essentially pure copper; the method has the advantage that the metal melt may be infiltrated at process temperatures which are lower than the melting point of copper, and that the resulting composite component has essentially pure copper as the metal phase, so that the maximum service temperature of the resulting component may be in the range of the melting point of copper, i.e., in the range of 1,083° C. The infiltration temperatures in the method according to the present invention, which are lower in comparison to infiltration of pure copper, result, among other things due to shorter heating phases, in shorter process times and thus also in lower manufacturing costs. Moreover, the thermal stress of a casting tool utilized and of the blank is lower. In addition, smaller amounts of gas are dissolved in the metal melt.

The method according to the present invention is particularly suitable for manufacturing components which are designed for tribological applications. Brake disks of a motor vehicle, whose maximum service temperature is advantageously higher than 800° C., may be manufactured using the method, for example. This is the case for a metal-ceramic composite component whose metal phase is essentially made up of pure copper.

A composite component manufactured using the method according to the present invention is characterized by great wear resistance and corrosion resistance, great damage tolerance and high thermal conductivity.

In a preferred embodiment of the method according to the present invention, the metal melt is infiltrated at a temperature of between approximately 680° C. and approximately 1,000° C.

Infiltration of the metal melt takes place under a pressure of between approximately 100 bar and approximately 300 bar, it being possible, subsequent to the infiltration, to exert a post-pressure of approximately 300 bar to 700 bar on the infiltrated blank for a period of approximately 1 min to 5 min in order to avoid formation of cavities due to shrinkages.

In order to obtain a composite component which, in comparison with a blank infiltrated with pure copper, is characterized by lower weight, a metal alloy is preferably infiltrated in which the additional metal has a lower specific weight than copper. A CuMg alloy, a CuAl alloy, a CuSi alloy, a CuZr alloy, or a CuTi alloy is used as the alloy, for example. All of these alloys are alloys whose melting point is below the melting point of pure copper.

The reactive components of the blank may be formed by at least one oxide, TiO₂ and/or ZrO₂ in particular, of at least one carbide and/or at least one nitride.

The conversion of the additional alloy element and the reactive ceramic compound may take place either during infiltration of the metal melt, i.e., in situ, or during controlled post-heating. In the latter case, the infiltration conditions should be controlled in such a way that a partial reaction occurs in the surface area of the reactive ceramic compound, thereby facilitating the infiltration. Similar to a conversion during infiltration, the chemical reaction results in an infiltration pressure reduction. This is due to the released reaction heat and the changed surface tension due to the phase newly formed by the conversion.

In a particularly advantageous embodiment of the method according to the present invention, the blank receives a porosity of approximately 50% by volume, so that proper reaction conditions prevail for the conversion of the alloy element which is lighter than copper. This results in a lower over all density of the finished material.

The blank may be manufactured in such a way that it includes components which are inert vis-à-vis the metal melt and which are in particular made of particles or fibers which are formed by an oxide, a carbide, a nitride, or a boride. An oxide is, for example, aluminum oxide Al₂O₃ or zirconium dioxide ZrO₂; a carbide is, for example, silicon carbide SiC, titanium carbide TiC, tungsten carbide WC, or boron carbide B₄C; a nitride is, for example, silicon nitride Si₃N₄, boron nitride BN, aluminum nitride AlN, zirconium nitride ZrN, or titanium nitride TiN, and a boride is, for example, titanium boride TiB₂. The inert components may be used in particular as reinforcing elements and/or functional elements for the finished composite component. Silicon carbide or aluminum nitride, for example, increases the thermal conductivity of the finished material. Ceramic fibers increase the stability and the fracture toughness of the finished material.

The object of the present invention is also a metal-ceramic component, a brake disk in particular. The component includes a ceramic phase which has a pore space which is essentially filled with pure copper. According to the present invention, the ceramic phase includes a conversion product made up of a reactive ceramic component and a metal of a copper alloy which has a specific weight lower than copper.

The metal-ceramic component according to the present invention represents a component which is characterized by favorable properties with regard to its density and thus with regard to its weight.

To avoid high thermal gradients or high thermal stresses, which may occur in a tribologically stressed component due to a great energy input when exposed to friction, the component advantageously has a thermal conductivity λ of more than 70 W/mK which may be ensured by an appropriate content of copper by volume. Copper has a thermal conductivity of 400 W/mK.

In order to provide the metal-ceramic component with a sufficient damage tolerance for use as a brake disk, the component advantageously has a fracture toughness greater than 10 MPa·m^{1/2}, preferably greater than 15 MPa·m^{1/2}.

Calibration of the above-mentioned thermal conductivity and the above-mentioned fraction toughness may be achieved in the component according to the present invention in particular when it has a copper content between 20% by volume and 45% by volume, preferably between 25% by volume and 40% by volume, and a corresponding ceramic proportion between 55% by volume and 80% by volume, preferably between 60% by volume and 75% by volume.

Six exemplary embodiments of the method according to the present invention are described in greater detail in the subsequent description in connection with corresponding metal-ceramic components according to the present invention.

### DETAILED DESCRIPTION

In a first variant of the method according to the present invention, a porous ceramic blank, having the form of a brake disk, is initially produced, which has a porosity of approximately 50% by volume and is made up of inert and reactive components. The inert components of the blank are formed of silicon carbide. The reactive components are formed of titanium dioxide. The ceramic blank is a sintered body which is formed by sintering a green body which is compacted from a powder.

The sintered blank is filled or infiltrated in a die-casting mold or a casting mold with a melt of a CuAl alloy which has an aluminum content of 67% by weight. The melting point of this alloy is 548° C. The blank, infiltrated with the metal melt, is subsequently subjected to a controlled heating process in which aluminum reacts with titanium dioxide to form aluminum oxide and titanium aluminide. Copper having a high melting point remains as the metal phase. The metal phase fills a pore space of a ceramic phase which includes the aluminum oxide and the titanium aluminide. The component created in this way represents the finished brake disk.

In an alternative variant of the method according to the present invention, a porous ceramic blank, also having the form of a brake disk, which includes aluminum oxide Al₂O₃ as the reactive component, is initially produced. This blank is filled or infiltrated in a die-casting mold with a metal melt of a low melting CuMg alloy which has a eutectic composition, the copper content of the melt being 90.3% by weight and the melting point of the alloy being 722° C. The reactive magnesium oxidizes during infiltration of the ceramic blank with the aluminum oxide so that a conversion takes place into a ceramic phase formed from spinel MgAl₂O₄, and copper remains as the metal phase of the resulting component representing the finished brake disk.

The ceramic blank may alternatively include titanium dioxide TiO₂ as the reactive component which is converted into MgTiO₃ by the magnesium of the metal melt.

In a further variant of the method according to the present invention, a ceramic blank is initially produced for the manufacture of a brake disk, which includes titanium dioxide TiO₂, i.e., a ceramic oxide, as the reactive component.

The ceramic blank is infiltrated in a die-casting mold with a metal melt made of a CuSi alloy whose silicon content is 8% by weight and whose melting point is 680° C.

The infiltrated blank is subsequently subjected to a controlled temperature treatment, so that the silicon of the metal melt including the ceramic oxide TiO₂ is converted into a titanium silicide, e.g., TiSi₂ and/or Ti₅Si₃. Essentially pure copper remains as the metal phase of the finished brake disk representing a metal-ceramic component.

In a further variant of the method according to the present invention, a ceramic blank is produced which includes a reactive component which acts as an oxidant vis-à-vis zirconium Zr. The blank has a pore volume of approximately 50% by volume.

The blank is subsequently infiltrated with a metal melt made of a CuZr alloy which has an eutectic composition and whose melting point is 972° C. The zirconium content in the alloy is 11.5% by weight. The zirconium of the metal melt is converted into zirconium dioxide ZrO₂ via the oxidatively acting compound of the ceramic blank. Copper remains as the metallic phase of the finished metal-ceramic component representing a brake disk, for example.

In a further variant of the method according to the present invention, a ceramic blank is produced for the manufacture of a brake disk having a reactive component which acts as an oxidant vis-à-vis titanium. This blank is infiltrated in a die-casting mold with a metal melt made of a CuTi alloy of eutectic composition which has a titanium content of 25 atom % and a melting point of 885° C. The titanium of the metal melt is converted into titanium dioxide TiO₂ via the oxidatively acting compound of the ceramic blank. Copper remains again as the metal phase of the finished metal-ceramic component.

The present invention is not restricted to the above-described exemplary embodiments and in particular not to the manufacture of brake disks. Moreover, a plurality of ceramic blanks may be used in a form adapted to the individual application which include a component which acts reactively vis-à-vis an alloy component so that, during infiltration of a metal melt formed as an alloy of copper and an additional metal, the additional metal may be converted into a ceramic phase and the metallic phase of the finished component is essentially composed of pure copper.

1.-14. (canceled)

15. A method for manufacturing a composite component, comprising:
producing a porous ceramic blank;
one of infiltrating and filling the blank with a metal melt, wherein:
the metal melt includes an alloy of copper and at least one additional metal; and
converting the additional metal via a reaction with at least one reactive component of the blank in such a way that a pore space of a ceramic phase is filled with essentially pure copper.

16. The method as recited in claim 15, wherein the composite component includes a brake disk.

17. The method as recited in claim 15, further comprising:
infiltrating the metal melt at a temperature that is lower than a melting point of copper.

18. The method as recited in claim 17, wherein:
the temperature is between approximately 680° C. and 1,000° C.

19. The method as recited in claim 15, wherein the blank, infiltrated with the metal melt, is subjected to controlled post-heating.

20. The method as recited in claim 15, wherein the blank has a porosity of approximately 50% by volume.

21. The method as recited in claim 15, wherein:
the at least one additional metal has a lower specific weight than copper, and
the at least one additional metal includes one of a CuMg alloy, a CuAl alloy, a CuSi alloy, a CuZr alloy, and a CuTi alloy.

22. The method as recited in claim 15, wherein the at least one reactive component of the blank includes at least one oxide of at least one of at least one carbide and at least one nitride.

23. The method as recited in claim 22, wherein the at least one oxide includes at least one of TiO₂, Al₂O₃, and ZrO₂.

24. The method as recited in claim 15, wherein the blank includes constituents which are inert vis-à-vis the metal melt and are made of one of particles and fibers formed by one of an oxide, a carbide, a nitride, and a boride.

25. The method as recited in claim 24, wherein the inert components of the blank are used as at least one of reinforcement elements and functional elements of the finished composite component.

26. A metal-ceramic component, comprising:
a ceramic phase provided with a pore space filled with essentially pure copper, wherein the ceramic phase includes a conversion product that has a lower specific weight than copper, the conversion product including a reactive ceramic portion and a metal of a copper alloy.

27. The metal-ceramic component as recited in claim 26, wherein the metal-ceramic component corresponds to a brake disk.

28. The metal-ceramic component as recited in claim 26, wherein:
the copper alloy is one of a CuAl alloy, a CuMg alloy, a CuSi alloy, a CuZr alloy, and a CuTi alloy, and
the conversion product is formed by aluminum oxide and titanium aluminide, MgAl₂O₄ or MgTiO₃, a silicide such as TiSi₂ or Ti₅Si₃, by zirconium dioxide ZrO₂, or titanium dioxide TiO₂.

29. The metal-ceramic component as recited in claim 26, wherein the component has a copper content between 20% by volume and 45% by volume, and a ceramic content between 55% by volume and 80% by volume.

30. The metal-ceramic component as recited in claim 26, wherein the component has a copper content between 25% by volume and 40% by volume, and a ceramic content between 60% by volume and 75% by volume.

31. The metal-ceramic component as recited in claim 26, wherein the ceramic phase includes at least one of particles and fibers made of at least one of at least one oxide, at least one carbide, at least one nitride, and at least one boride.

32. The metal-ceramic component as recited in claim 26, wherein the component has a fracture toughness greater than 10 MPa·m^{1/2}.

33. The metal-ceramic component as recited in claim 26, wherein the component has a fracture toughness greater than 15 MPa·m^{1/2}.

34. The metal-ceramic component as recited in claim 26, wherein the component has a thermal conductivity of more than 50 W/mK.

35. The metal-ceramic component as recited in claim 26, wherein the component has a thermal conductivity of more than 70 W/mK.
